(19) United States
(12) Patent Application Publication
(10) Pub. No.: US 2008/0199963 A1
(43) Pub. Date: Aug. 21, 2008

(54) Method of Determining Acid Content

(76) Inventors: Desmond Smith, Wiltshire (GB); Keith Robinson, Wiltshire (GB)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 11/742,856

(22) Filed: May 1, 2007

(30) Foreign Application Priority Data
Feb. 21, 2007 (GB) 0703366.5

(51) Int. Cl. G01N 31/16

(52) U.S. Cl. 436/61; 436/163

(57) ABSTRACT

A method for determining the TAN value of a hydrocarbon-containing composition, in which the sample is cleared of free water, heated to an elevated temperature in an oxygen free environment, conditioned at the elevated temperature for an extended period of time, cooled down to a temperature near to room temperature, and titrated against alcoholic potassium hydroxide, whereby the TAN value may be calculated.

### CROSS REFERENCE TO RELATED APPLICATIONS

This application claims priority benefit under 35 U.S.C. §119(a) from Great Britain Patent Application No. GB 0703366.5 filed in the United Kingdom Intellectual Property Office on Feb. 21, 2007, the entirety of which is hereby incorporated herein by reference.

### BACKGROUND OF THE INVENTION

### Field of the Invention

The present invention is directed towards a method for the determining of acid content in hydrocarbon compositions and in particular oil compositions, for example crude oil.

An increasing number of new oil reservoirs being discovered and developed in recent years are of heavier oils (American Petroleum Institute (API) gravities of 15 degrees to 25 degrees) that show high total acid values and high naphthenic acid contents. In refineries these are known as High Acid Crude (HAC) feedstocks. The Total Acid Number (TAN) values (milligrams of potassium hydroxide (KOH) per gram of oil) of such oils, as conventionally analyzed in accordance with, for example, ASTM D664 and UOP 565-05, do not correlate at all with their risk of forming naphthenate or other soaps during production in oilfields.

By strict definition, a naphthenic acid is a monobasic carboxy group attached to a saturated cycloaliphatic structure. However, it has been a convention accepted in the oil industry that all organic acids in crude oil are called naphthenic acids. Naphthenic acids in crude oils are mixtures of low to high molecular weight acids. This definition will apply in the present application.

These naphthenic acids can be very water-soluble to oil-soluble depending on their molecular weight, process temperatures, salinity of waters, and fluid pressures. In the water phase, naphthenic acids can cause stable reverse emulsions (oil droplets in a continuous water phase). In the oil phase with residual water, these acids have the potential to react with a host of minerals, which are capable of neutralizing the acids. The main reaction product found in practice is the calcium naphthenate soap (the calcium salt of naphthenic acids).

These reaction products often become insoluble salts, and form solids material that can plug production systems, eventually causing system shutdowns. Analysis of these soaps, however, indicates that in addition to the formation of calcium soap, it is possible to also generate a mixture of magnesium, sodium, potassium, iron, and aluminum soaps with occluded formation-derived sand, silts and clays, mineral scales, iron scales, asphaltenes, resins, waxes, and treating chemicals.

Several gas chromatography and combined (and expensive) mass spectrometric analytical procedures have not been able to give quantitative levels of specific precursor problematic acids prone to generating these soaps. Other methods involve use of a pilot plant to determine the organic scale-soap probability under a combination of synthesized conditions. None of these have proved effective at accurately indicating the level of acid precursors present in a hydrocarbon composition.

Hydrocarbons present in crude oils as the major classes comprise the aliphatic paraffin series, the aromatic benzene series, and the polymethylene cycloparaffinic naphthene series. Generally the carbon/hydrogen content ratio is around 85/12. Also found in crude oils are many sulphur, oxygenated, and nitrogenous species of compounds—fatty acids, naphthenic acids, volatile organic acids, phenols, resins, thiophenes, mercaptans, sulphones, sulphonic acids, pyridines, sulphoxides, quinolines, etc.

Strong, stable and persistent emulsions in the production and refining of crude oils pose a challenge to understand on a molecular level. The emulsions are derived from the natural surfactants in crude oils. The main chemical responsible for emulsions and foams is naphthenic acid. The desalter emulsions release “clean crude,” but relatively high concentrations of these emulsions are very stable and can result in sludge generation. Resins and asphaltenes play important roles here in forming rigid films at the oil-water interface.

In addition, naphthenic acids have been found to cause the formation of soaps. Soaps are organic acid carboxylates. The alkali metals soaps/salts, sodium and potassium naphthenates, are water-soluble and water-dispersible, giving tight emulsions and poor oil-in-water qualities. Naphthenic acid soaps of the alkaline earth metals are insoluble in normal oilfield brines, with a pH greater than seven at normal upstream process temperatures, and cause a host of production problems with frequent shutdowns, decreased production rates, and costly maintenance programs.

Crude oils containing naphthenic acids are shipped as sales crudes to refineries where tank bottom sludges, poor inlet tank dehydration, and overloaded slops processes are experienced. A catalogue of problems may follow on from the charge to the crude distillation unit, examples of which are fouling in preheater furnaces, generation of polymers from olefins, preheat exchanger fouling, corrosion at inlet zones to crude distillation unit (CDU), light acids cleavage to volatile organic acids (VOA's), corrosion upper side, and corrosion bottoms of unit and poor product stream qualities.

The acid value (TAN) of crude oils plays an important role in trying to predict problems that may be experienced in production and refining of these crude oils.

Regardless of the source, the acids present in the oil cause much corrosion in the refinery equipment. The most common current measures of the corrosive potential of a crude oil are the Neutralization Number (Neut Number) or Total Acid Number (TAN). These are total acidity measurements determined by base titration. Commercial experience reveals that while such tests may be sufficient for providing an indication of whether any given crude may be corrosive, the tests are poor quantitative indicators of the severity of corrosion.

As world markets evolve toward use of heavier crude oils, rich in heteroatom content, then the composition of these crude oils will become very important in production and refining terms. Deposits forming in heavy crude often pose challenging problems, the solutions of which can assist in process designs and in the understanding of the deposit formation. TAN value, if high, is one characteristic among others, e.g. yield values of the crude oil, that can encourage crude on world markets to be discounted, sometimes substantially.

Current methods for the determination of the acid content of hydrocarbon compositions are well established. The Handbook of Petroleum Product Analysis, Speight, 2002, pg 49 summarizes the acid value methods which are recognized in the petroleum sector. ASTM D664 (IP 177) includes potentiometric titration in non-aqueous conditions to clearly defined end points as detected by changes in millivolts readings versus volume of titrant used. A color indicator method, ASTM D-974, (IP 139) is also available, but it can be difficult to observe color changes in crude oil solutions. Speight noted that the results from the color indicator method may or may not be the same as the potentiometric results.

Other methods are available for oxidized oils under laboratory oxidation tests (ASTM D-943 Oxidation test) The color indicator method, ASTM D3339, (IP 431), uses smaller amounts of samples than used in ASTM D-664 or ASTM D-974, and although this reduces the background color it is still difficult to use with crude oil samples.

The acidity of jet fuels has a specific test, ASTM 3242 (IP 354) using a color indicator method and alcoholic KOH titrant. The saponification of bitumen (The Handbook of Petroleum Analysis, Speight, 2002, p331) describes a method for bitumen/asphalt whereby the sample is heated up in methyl ethyl ketone with a known amount of alcoholic KOH, for thirty to ninety minutes at the loop eighty decrees Centigrade. The excess KOH is back-titrated with standard hydrochloric acid and the saponification number is then calculated. This represents a measure of the carboxylate soaps and excess free acids.

Among the oilfields found and developed around the world, an increasing number of the crude oils contain naphthenic acids and have a high TAN value. Producing and refining high TAN crude oils introduces a number of challenges, e.g. calcium naphthenate deposition in process facilities offshore, and corrosion in refinery process equipment. Calcium and magnesium soaps of low water solubilities form in production lines and separators causing severe operational problems, involving shutdowns and expensive maintenance problems, which can cost millions of dollars.

Normally, the end result of formation of low molecular weight acidic species is treated in the overheads in refineries. A combined approach to front end treating at crude inlet to heaters and preheat exchangers should be considered. It is commonly assumed that acidity in crude oils is related to carboxylic acid species, i.e., components containing a —COOH functional group. While it is clear that carboxylic acid functionality is an important feature (sixty percent of the ions have two or more oxygen atoms), a major portion (forty percent) of the acid types are not carboxylic acids. Even the carboxylic acids are more diverse than expected, with approximately eighty-five percent containing more heteroatoms than the two oxygens needed to account for the carboxylic acid groups. Examining the distribution of component types in the acid fraction reveals that there is a broad distribution of species.

Typically, eight different component types are present in quantities ranging from twenty to thirty-five Moles per 10,000 whole crude carbons, including O₂, O₄, S, N₂, NO, NO₂, N₂O, and N₂O₂. The presumption of O₂-only species as suggested by the term “naphthenic acids” is clearly not valid for such oil. Judging from the presence of these species in the acid extract, the most likely compound types in these categories would be carboxylic acids for species with two or more oxygen atoms, pyroles/carbonazoles/indoles for N-species, phenols for single oxygen species, and thiols for the sulfur species (see On the Nature and Origin of Acidic Species in Petroleum .1. Detailed Acid Type Distribution in a Californian Crude Oil, Tomczyk N. A et al, Energy and Fuels, 2001, 15, 1498-1504).

A new set of naphthenic acids, called the ARN acids of m/z 1230 amu (mass over charge) have also been identified in present day organic scales and crude oils. For example, in the Colorado Green River, shale of the Eocene era, rich organic matter, has been extensively studied. These investigations included analyses of normal and isoprenoid alkanes, steranes, and triterpanes. Fatty acids have been reported and a homologous series of fatty acids has been observed.

The total acid matrix is therefore complex and it is unlikely that a simple titration, such as the traditional TAN methods, can give meaningful results to use in predictions of problems. An alternative way of defining the relative organic acid fraction of crude oils is therefore a real need in the oil industry, both upstream and downstream.

An object of the present invention is therefore to provide such a method and to use such a method to rank oils with respect to their risk of generating soap problems in oilfield production and crude refining plants.

### SUMMARY OF THE INVENTION

The disadvantages and limitations of the background art discussed above are overcome by the present invention. According to the present invention, there is provided a method for determining the TAN value of a hydrocarbon-containing composition, in which the sample is cleared of free water, heated in an oxygen free environment, cooled, and titrated against alcoholic potassium hydroxide to calculate the TAN value.

According to one embodiment of the present invention, excess alcoholic potassium hydroxide may be back-titrated to an end point with alcoholic hydrochloric acid using a potentiometric titrator. The end point is automatically determined by the inflexion change in millivolts readings versus the volume of titrant used. This end point gives the volume of HCl used to neutralize the excess KOH. A calculation is then performed to determine the volume of KOH used for neutralization of acidic species in the sample. The TAN value (mg KOH/g) is now calculated from the volume of KOH used and the weight of sample taken, and for this new or modified method we shall designate this as Modified TAN.

According to another embodiment, the sample is titrated directly against alcoholic potassium hydroxide. The direct measurement of the amount of KOH used is put into the equation (with the weight of sample used) to calculate the Modified TAN value for the sample.

Based on the stereochemistry of the high molecular weight naphthenic acids (see, for example The Discovery of High-Molecular-Weight Naphthenic Acids (ARN Acid) Responsible for Calcium Naphthenate Deposits, Baugh et al, SPE Paper 93011, 2005), an interpretation had been noted that these high molecular weigh acids are not linear at titration laboratory temperatures. It is thought that these ARN Acid molecules are coiled, hydrogen-bonded molecules that cannot accept all the neutralizer molecules. It is therefore an important step in the process of the present invention to heat the hydrocarbon-containing samples to elevated temperatures over a number of hours under an oxygen free atmosphere. In order to obtain an accurate determination of the modified TAN value, either or both of an air and/or water cooled condenser may be present to collect light ends which evaporate off during the heating and conditioning steps.

Increasing time and temperatures have shown increasing TAN values, which reaches a maximum, within experimental errors. For example, three hours at the loop eighty degrees Centigrade can be used for very viscous bitumens, decreasing to seventy degrees Centigrade for three hours for medium API crude oils. Table 1 below sets out the optimum temperatures and times for a range of different API crude oils.

The specific acids may be tetramer acids, in the molecular weight range of 1227 to 1235 Da (amu). The acids homologous series corresponds to empirical formula of C₈₀H₁₃₈O₈, C₈₀H₁₄₀O₈, C₈₀H₁₄₂O₈, C₈₀H₁₄₄O₈, and C₈₀H₁₄₆O₈ with double bond equivalences (DBE) ranging from twelve to eight, indicating eight to four rings in the hydrocarbon skeleton, respectively.

This technique holds great potential as a screening tool for oil and refinery fractions, for new fields, refinery crude oil slates and product streams. The method can be used on current refinery and production operations for troubleshooting present problems.

References to naphthenic acid include naphthenate and vice versa unless the context clearly specifies otherwise.

Hydrocarbon compositions, which can be analyzed by a method of the invention, include crude oil, or partially purified crude oil, or an oil or substance obtained from crude oil following subsequent crude oil distillation, for example petroleum, kerosene, or paraffin. The method may be practiced on samples obtained from crude oil directly, or from sludges, oil deposits, oil emulsions, bitumens, asphalts, or tars which have been prepared for sample analysis. The method covers such samples as received from crude oil production, drilling, completion, and oil refining and petrochemical processes.

The crude oil may be a raw extract from a ground reservoir of oil following extraction, or it may be present in a refinery product stream, such as a distillate, fraction, or other liquid residue from a process unit. The hydrocarbon composition may also be dispersed in water, extracted and subjected to the test procedure. Methods of the invention are therefore applicable to the analysis of wastewater from a refinery, sludges from pits, and water clarification units where the hydrocarbon composition is dispersed in the water and is extractable prior to TAN determinations.

Preparation for sample analysis may include appropriate steps to remove particulate and/or solid matter, excess water or other impurities. Excess water may be removed by a process of alternate heating and cooling of the sample, by gravity separation, e.g. in a separatory funnel, or by centrifugation to remove the water. Alternatively, the water may be removed manually. The heating process may be carried out in an inert atmosphere, e.g. under nitrogen or helium or other inert gases.

The present invention therefore also provides methods applicable to crude oils, deposits, process disposal water, refinery product streams, overheads in refinery units and bottoms asphalts to determine the acid values of these samples to enable diagnostic tools for problem solving or prediction of problems.

### DESCRIPTION OF THE DRAWINGS

The present invention will now be further described with reference to the following examples, which are provided for the purposes of illustration only and are not to be construed as limiting on the invention. Reference is made to the following figures, in which:

FIG. 1 shows schematically apparatus for operating the method of the present invention;

FIG. 2 shows graphically, for a range of crude oils, a comparison between TAN values measured according to the present invention and TAN values measured by standard techniques;

FIG. 3 shows graphically, for different crude oils, the effect of different conditioning times at the same temperature using the method of the present invention;

FIG. 4 shows graphically, for different crude oils, the effect of increasing temperature on the modified TAN values obtained using the method of the present invention; and

FIG. 5 shows graphically, for different crude oils, a comparison of the modified TAN results obtained according to the method of the present invention with standard TAN data and a predicted naphthenate probability index.

### DETAILED DESCRIPTION OF THE PREFERRED EMBODIMENT

A hydrocarbon sample is homogenized by shaking. For viscous crude oils, low API's of fifteen to twenty degrees, it is recommended by the standard method (ASTM D664) to heat the sample to sixty degrees Centigrade, shake it, then take a certain weight depending on the expected TAN value. This is a heating step to reduce viscosity and aid mixing, but does not compare with the heating steps of the method of the present invention, which are to facilitate reaction of the KOH with relatively inaccessible sites on the complex, perhaps tetraprotic, naphthenic acid molecules. All standard weighings are traditionally stipulated at twenty degrees Centigrade, so a cooling step is necessary for the standard ASTM D 664 test.

The sample is centrifuged to remove free water. The percentage of water is recorded in the template set out below in Table 2. For produced samples, the emulsion is not drained off but retained with the rest of the crude oil as these emulsions contain naphthenic acids. The free crude oil separated as a bulk upper layer in the centrifuge tube and lower layer residual emulsions are combined, shaken to mix, and is ready for the test.

In analyzing other samples (i.e. not viscous crude oils) for TAN values, e.g. sludges, drilling fluids, drilling muds, production interfaces, or effluent waters from desalters or separators, water is removed from all samples by centrifuging. Another method of removing large volumes of water is using a separatory funnel.

For smaller amounts of water, a further technique for the removal of the water is as an azeotrope with acetone on a water bath at seventy degrees Centigrade with a gentle nitrogen sparge. The water is removed to constant weight of the residue, with an oven finish at sixty degrees Centigrade.

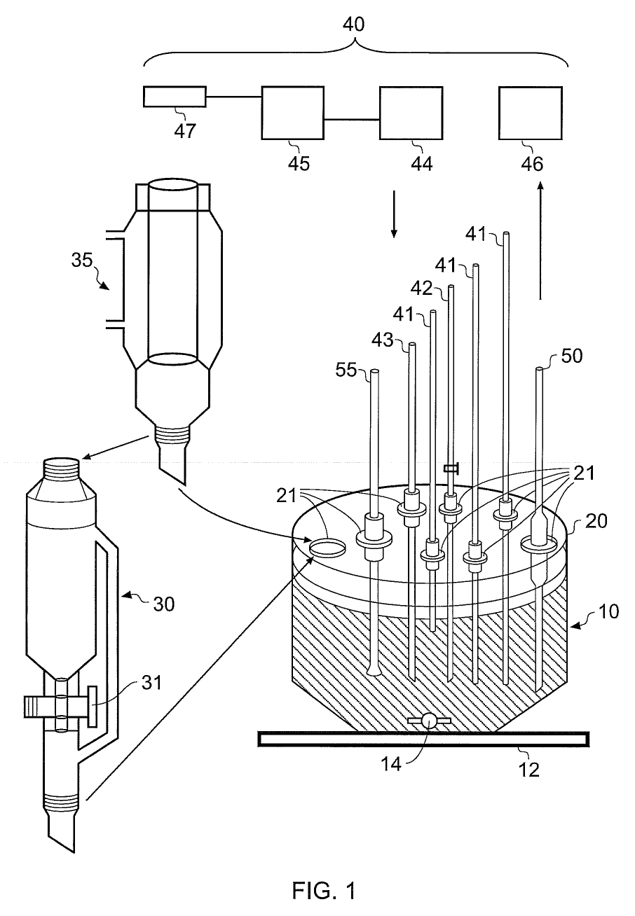

FIG. 1 shows the apparatus for operating the method of the present invention. A reaction cell 10 is fitted with a lid 20, through which there are holes 21 to fit probes, thermometers, fluid inlet lines, and condensers, as appropriate. The reaction cell 10 is placed on a hot plate 12, which has a variable speed magnetic stirrer 14 capable of operating within the desired temperature range (twenty-five to one hundred degrees Centigrade). The apparatus also optionally includes either or both of a small air condenser 30 and a water condenser 35. A potentiometric titrator 40 of standard form is connected to the reaction cell 10. The potentiometric titrator comprises a pair of electrodes 41, a burette 42 for addition of KOH, an input line 43 for the titrant from the titrator 44, a dispenser 45 for the KOH or other titrant in use, a recorder 46 for recording the changes in voltage, and a keypad 47 for control of the titration. The reaction cell 10 also has a hole 21 in the lid 20 for a nitrogen sparge 50 and a hole for a thermometer 55.

A sample weight of the crude oil to be tested is placed in the reaction cell 10. The sample weight is calculated depending on the suspected TAN or MOD-TAN values—which may be estimated from the API gravity (see Table 1 below). The reaction cell 10 is charged with the sample weight and set up in a water bath on a hot plate. When using small amounts of samples, e.g. less than five grams, four to five milliliters of solvent (400 ml N-Heptane+600 ml Iso propanol) is added as a make-up. This is a preferred solvent but the solvent may comprise hydrocarbons in the range C₅-C₁₀, preferred nC₇, and the alcohol can range C₂-C₁₀, preferred isopropanol (iso C₃ Alcohol).

For crude oil of very high API gravity (e.g. greater than thirty-five API) or if testing refinery crude unit distillation tower fractions e.g. jet fuel, kerosene, light gas oils, etc., or light fractions from other refinery units, it will be necessary to attach the air condenser 30 first, and then the water condenser 35 to the air condenser 30 (with the tap in the closed position).

The water condenser 35 is started at a medium rate water flow, for example one liter per minute, but this may vary depending on the water pump size, the diameter of the line, and the length of line. The thermometer 55 and the nitrogen sparge 50 are put in place, and the nitrogen sparge 50 is switched on at one bubble per second. The magnetic stirrer 14 is set to swirl at a low rate, and the water bath temperature is set at a first set point of thirty degrees Centigrade. This is gently increased to the required temperature in the range of seventy to eighty degrees Centigrade.

Table 1 below sets out suggested operating parameters for a given API gravity. This includes suggested operating temperature and time for conditioning the sample at the operating temperature, once reached. During the conditioning, the sample is monitored to observe if there are any condensates or light fractions collected on the walls of the condensers 30 and 35. The sample is allowed to cool to forty degrees Centigrade by reducing the temperature setting on the hot plate. If liquids have condensed in either of the condensers 30 or 35, they are washed down with one milliliter increments of the n-Heptane-IPA solvent described above back into the reaction cell 10. The quantity of solvent (z ml) used for washing down the condensers is recorded. The water condenser 35 is disconnected, and the tap 31 on the air condenser 30 is closed. Additional solvent volume (60-z) ml is added to the air condenser 30, along the walls of the glass, the tap is opened, and the solvent passes into the reaction vessel 10 and the heated crude oil. The tap 31 on the air condenser 30 is closed.

TABLE 1

| | | | | Volume | | |
|---|---|---|---|---|---|---|
| | | | Volume | 0.1N | | |
| | | Weight | make- | KOH to | Temperature | Time for |
| API | Sus- | of | up | be | for | con- |
| gravity, | pected | Sample | solvent | added | conditioning | ditioning |
| degrees | TAN | (g) | (ml) | (ml) | (° C.) | (hours) |
| 15-20 | >5 | 3 | 4 | >6 | 80 | 3 |
| 20-30 | 3-5 | 3-5 | 4 | 5-10 | 70 | 2 |
| 30-70 | 1-3 | 4-6 | 4 | 3-6 | 70 | 2 |

### Titration of Excess Alcoholic KOH by Back Titration Method

The titrator 40 is prepared to be ready to run using alcoholic hydrochloric acid or perchloric acid. Sample data for the case is input and the titrant is zeroed off. The titrator 40 is connected up to the reaction cell 10, but the electrodes 41 and titrant nozzle 43 are not yet inserted into the liquid crude oil. The titrator 40 is set up for AUTO RUN.

Referring to Table 1 above, the listed volume of 0.1 N alcoholic KOH is carefully added to the reaction cell. The exact volume of alcoholic KOH used is recorded (x ml). The temperature of the liquid in the cell is measured and gradually increased to thirty-five degrees Centigrade and allowed to stand and stabilize for five minutes. The electrodes 41 and titrant nozzle 43 are carefully inserted into the liquid, and the titrator 40 is started. The titrator 40 is allowed to AUTO RUN and AUTO DETECT END POINT and thereby measure and calculate the volume (y ml) of alcoholic HCl used.

The modified TAN value for the sample is now calculated using the following equation:

$$\begin{matrix}MOD \text{-} TAN of Sample = \frac{[ \begin{matrix}( x - y ) * normality 0.1 N * \\ ( 56100 / 1000 ) mg\end{matrix} ]}{Weight sample ( g )} \\ = mg KOH / g Sample\end{matrix}$$

As an alternative, the modified TAN value can be calculated directly using a forward titration method. The method as set out above is followed until the point of addition of the alcoholic KOH to the reaction cell 10—i.e. in this case, no alcoholic KOH is added. Before inserting any electrodes 41 or nozzles 43, the temperature of the liquid in the reaction cell 10 is measured and increased to thirty-five degrees centigrade, and allowed to stand and stabilize for five minutes. Then, the electrodes 41 and nozzle 43 are carefully placed in the reaction cell 10 and the titrator 40 titrates directly with alcoholic KOH, again using the AUTO RUN and AUTO DETECT END POINT settings.

The modified TAN value for the sample is now calculated using the following equation:

$$MOD \text{-} TAN of Sample = \frac{[ \begin{matrix}ml 0.1 Alcoholic KOH * \\ 0.1 N * ( 56100 / 1000 )\end{matrix} ] mg}{weight of sample in grams}$$

### Calibration

The titrator 40 is calibrated before use, once a day in operation, and whenever a new batch of titration solvent is used. Calibration is carried out using the above methods on a mixture of glacial acetic acid (0.1760 g, Analar Grade>99% purity) in neutral paraffin oil (51.9870 g). The calibration result should read 3±0.02 mg KOH/g.

### Experimental Results

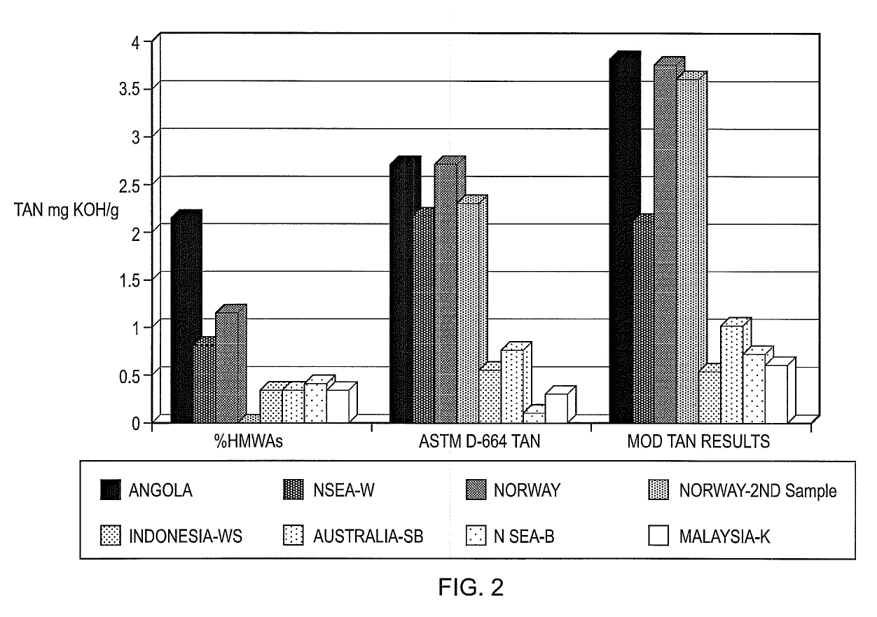

Below are the results of measurements made using the method of the present invention on a selection of crude oils taken from different fields around the world. These samples have different percentages of high molecular weight acids (HMWA), and therefore have different TAN values. The modified TAN values obtained by the method of the present invention are then compared to the TAN value measured using the standard method under ASTM D-664. The results are tabulated in Table 2 and shown graphically in FIG. 2.

TABLE 2

| | | TAN ASTM | TAN by Modified |
|---|---|---|---|
| Sample Identity | % HMWAs | D-664 | Method |
| ANGOLA | 2.13 | 2.70 | 3.83 |
| NSEA-W | 0.80 | 2.16 | 2.10 |
| NORWAY | 1.14 | 2.70 | 3.75 |
| NORWAY-2^{nd} | | 2.30 | 3.60 |
| Sample | | | |
| INDONESIA-WS | 0.33 | 0.54 | 0.59 |
| AUSTRALIA-SB | 0.33 | 0.75 | 1.01 |
| N SEA-B | 0.43 | 0.09 | 0.77 |
| MALAYSIA-K | 0.35 | 0.31 | 0.64 |

Referring to Table 2 and FIG. 2, the results show that the modified TAN results obtained using the method of the present invention are generally higher in value than the ASTM D-664 results. Special reference is made to N SEA-B results, which shows low TAN (0.09 mg KOH/g) by ASTM D-664, but using the new test procedure, 0.77 MOD-TAN was obtained. Indonesia-WS does not contain a high concentration of tetraprotic acids and is not expected to show a relatively high increase in TAN values by the new method.

Australia-SB results show similar tetraprotic HMWAs as Indonesia-WS sample, but an in-house calculation for fouling did not correlate the two samples. However the new modified TAN method clearly shows the increased value for Australia-SB, in agreement with the prediction from in house calculations.

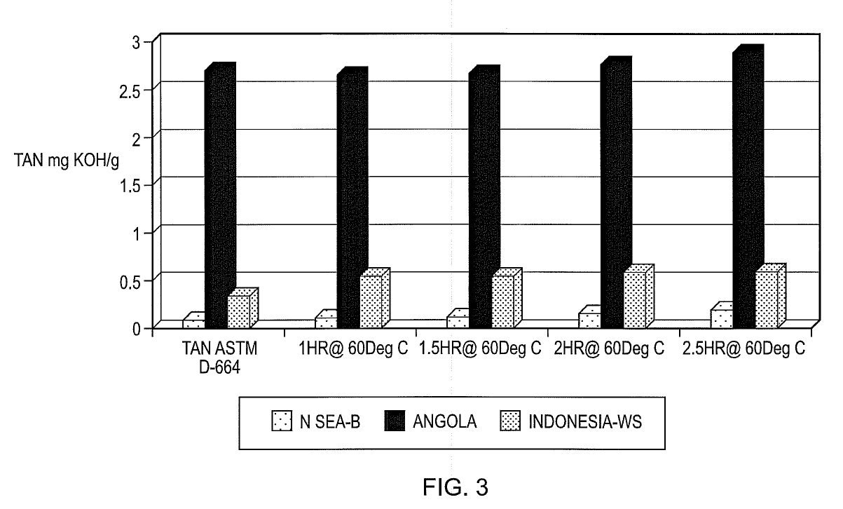

Below in Table 3 are results for the modified TAN values from the method of the present invention for different conditioning times at the same temperature. Again the results are compared with the standard TAN values measured according to ASTM D-664. The results are shown graphically in FIG. 3.

TABLE 3

| | | Modified TAN Test Condition | | | |
|---|---|---|---|---|---|
| | TAN ASTM | 0.5 HR@ | 1 HR@ | 2 HR@ | 2.5 HR@ |
| Sample Identity | D-664 | 60° C. | 60° C. | 60° C. | 60° C. |
| N SEA-B | 0.09 | 0.22 | 0.45 | 0.55 | 0.57 |
| ANGOLA | 2.70 | 2.66 | 2.78 | 2.87 | 2.90 |
| INDONESIA- | 0.54 | 0.53 | 0.55 | 0.57 | 0.57 |
| WS | | | | | |

Referring to the results shown in Table 3 and FIG. 3, it can be seen that there is a slow gradation in the modified TAN values as fixed heat is applied but time is varied.

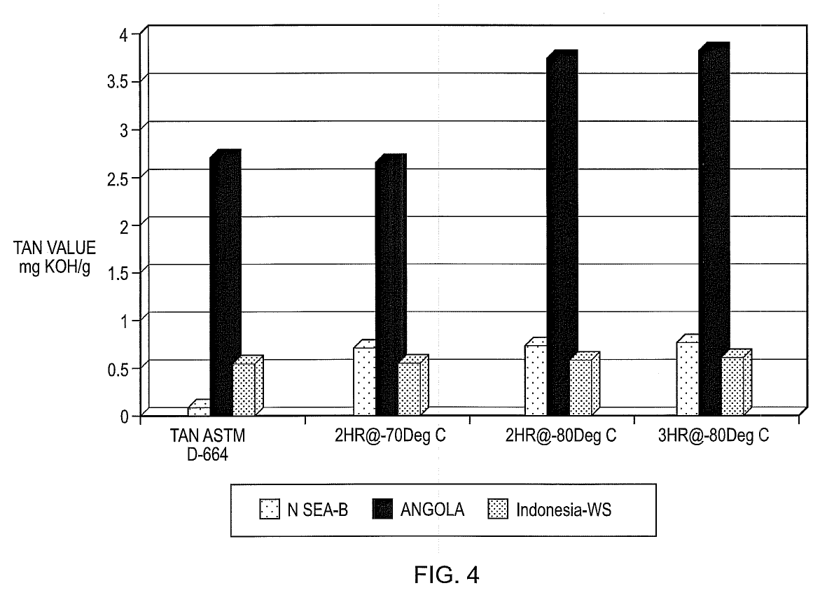

The results of varying the heat are expressed in Table 4 and are shown in FIG. 4. Indonesia-WS is a standard and is not expected to show increases in TAN values on heating as the naphthenic acids are more linear and are mainly of the fatty acid types. Angola sample, 18 deg API, may require higher temperatures, longer time parameters. N SEA-B shows increased TAN values more in correlation with the naphthenate soaps being experienced and in-house predictions.

TABLE 4

| | TAN ASTM | 2 HR@ | 2 HR@ | 3 HR@ |
|---|---|---|---|---|
| Sample Identity | D-664 | 70° C. | 80° C. | 80° C. |
| N SEA-B | 0.09 | 0.71 | 0.74 | 0.77 |
| ANGOLA | 2.70 | 3.20 | 3.77 | 3.83 |
| INDONESIA-WS | 0.54 | 0.55 | 0.58 | 0.59 |

The TAN values increase as heat is increased, then reach a plateau. The results show N SEA-B has a low TAN of 0.09 mg KOH/g by the ASTM D-664 method, but as temperature is increased the modified TAN's increase to 0.71-0.77 mg KOH/g.

Most striking features here are the increases in the modified TAN values for Angola, which increased from 2.70 TAN to 3.83 modified TAN. Indonesia-WS TAN values remain almost constant as predicted. This led to a consideration of the influence of degrees API on heating times. The graph in FIG. 4 shows that three hours/eighty degrees Centigrade for lower degrees API crude oils, e.g. Angola at 18 degrees API is an important test condition. For other crude oils, for example twenty to thirty degrees API and thirty to seventy degrees API, then two hours at seventy degrees Centigrade is recommended.

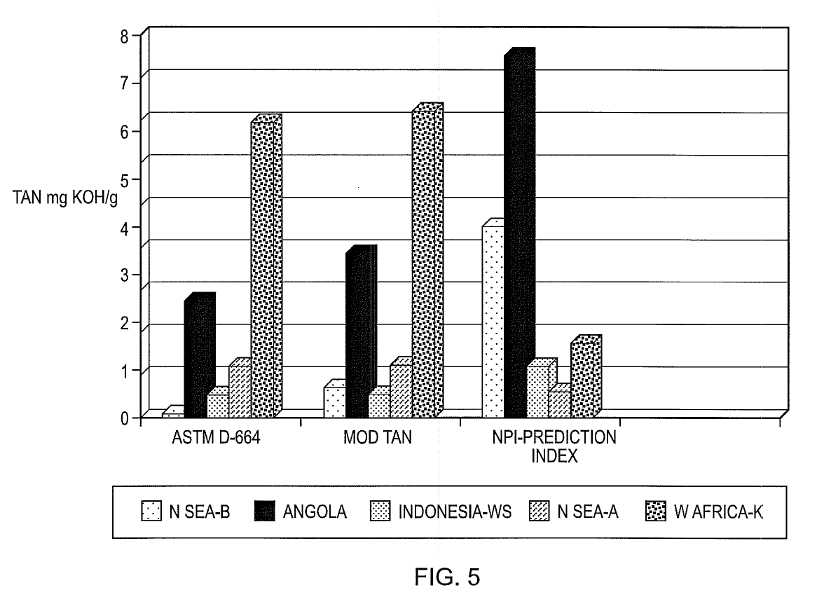

Table 5 shows the results of Modified Tan Tests under the conditions set out in Table 1 above for different API gravities v ASTM D664 and a comparison to Predicted Problems (NPI Index) FIG. 5 represents the results graphically.

TABLE 5

| | TAN ASTM | MOD | | NPI Prediction |
|---|---|---|---|---|
| Sample Identity | D-664 | TAN | % HMWAs | Index |
| N SEA-B | 0.09 | 0.77 | 0.43 | 4.5 |
| ANGOLA | 2.70 | 3.83 | 2.13 | 8.5 |
| INDONESIA-WS | 0.54 | 0.59 | 0.33 | 1.2 |
| N SEA-A | 1.2 | 1.25 | 0.2 | 0.6 |
| W AFRICA-K | 6.9 | 7.2 | 0.6 | 1.8 |

A predicted naphthenate probability index (NPI) of 4.5 and above, classifies the crude oil as being potentially problematic with respect to the influence of the HMWA's on operational problems. These acids have a direct relationship to the modified TAN values, except N SEA-A with a high TAN, but low percentage HMWA's and low NPI prediction. This suggests a high concentration of the percentage LMWA's is present in the N SEA-A sample.

W Africa-K has an appreciable ASTM D-664 TAN (6.9 mg KOH/g), which increased slightly on heating. Here the NPI prediction of 1.8 correlated as non-fouling in calcium soaps, being well below the 4.5 index. This crude in the refinery is noted as a high-calcium, emulsion-forming crude, but not an organic calcium naphthenate depositing crude.

The results show in FIG. 5 that the in-house predicted NPI suggests that values above 4.5 NPI should indicate problematic crude oils. This is directly related to the acid values, and especially the percentage HMWA's. N SEA-A and Indonesia-WS do not, in practice, give problematic operational problems of heavy organic soaps, and the NPI prediction and MOD TAN results show this correlation.

Consider N SEA-B, although almost having the same modified TAN value as Indonesia-WS, the index shows the probability of operational problems which is what is experienced in practice. Now judging from the ASTM D-664 test of 0.09 mg KOH/g TAN value, it would be unlikely to predict problems. However, the MOD TAN test gives 0.77 TAN value, a much higher value which correlates with the NPI prediction. Thus, the modified TAN test is a very important tool in understanding present and predicting future operational problems.

Although the foregoing description of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

What is claimed is:

1. A method for determining the TAN value of a hydrocarbon-containing composition, the method comprising:
providing a sample of the hydrocarbon-containing composition;
clearing the sample of free water;
heating the sample to an elevated temperature in an oxygen free environment;
conditioning the sample at the elevated temperature for an extended period of time;
cooling down the sample to a temperature near to room temperature;
titrating the sample against alcoholic potassium hydroxide; and
calculating the TAN value.

2. A method as defined in claim 1, wherein excess alcoholic potassium hydroxide is back-titrated to an end point with alcoholic hydrochloric acid using a potentiometric titrator.

3. A method as defined in claim 1, wherein the sample is titrated directly against alcoholic potassium hydroxide.

4. A method as defined in claim 1, wherein the elevated temperature is in the range of about 60 degrees Centigrade to about 100 degrees Centigrade.

5. A method as defined in claim 4, wherein the elevated temperature is in the range of about 70 degrees Centigrade to about 90 degrees Centigrade.

6. A method as defined in claim 5, wherein the elevated temperature is in the range of about 70 degrees Centigrade to about 80 degrees Centigrade.

7. A method as defined in claim 1, wherein the extended period of time is in the range of about 1 hours to about 5 hours.

8. A method as defined in claim 7, wherein the extended period of time is in the range of about 1.5 hours to about 4 hours.

9. A method as defined in claim 8, wherein the extended period of time is in the range of about 2 hours to about 3 hours.

10. A method as defined in claim 1, wherein the temperature near to room temperature is in the range of about 30 degrees Centigrade to about 40 degrees Centigrade.

11. A method as defined in claim 10, wherein the temperature near to room temperature is in the range of about 33 degrees Centigrade to about 38 degrees Centigrade.

12. A method as defined in claim 1, wherein the sample is cleared of free water by centrifuge of waste water, by evaporation of water under azeotrope conditions under a nitrogen blanket, by separatory funnels, by normal heat-cool procedures under nitrogen, or by a combination thereof.

13. A method as defined claim 1, wherein an oxygen free environment is provided by passing nitrogen.

14. A method as defined in claim 1, wherein the hydrocarbon-containing composition is one of crude oil, partially purified crude oil, and an oil or substance obtained from crude oil following subsequent crude oil distillation.

15. A method as defined in claim 14, wherein the sample is taken from crude oil directly, or from one of sludges, oil deposits, oil emulsions, bitumens, asphalts, and tars which have been prepared for sample analysis.

16. The use of the method as defined in claim 1 to screen oil and refinery fractions from one of new fields, refinery crude oil slates, and product streams.

17. A method for determining the TAN value of a hydrocarbon-containing composition comprising:
providing a substantially water-free sample of the hydrocarbon-containing composition;
determining the weight of the sample;
heating the sample in a substantially oxygen free environment to an elevated temperature of about 60 degrees Centigrade to about 100 degrees Centigrade;
conditioning the sample at the elevated temperature for a time period of about of about 1 hour to about 5 hours;
cooling the sample to a lower temperature of about 30 degrees Centigrade to about 40 degrees Centigrade;
titrating the sample with a sufficient volume of a titrant to provide a titration reaction endpoint; and
calculating the TAN.

18. The method of claim 17, wherein the titration step is performed using automatic potentionmetric titration.

19. The method of claim 18, wherein the titrant is one of alcoholic KOH and alcoholic HCL.

20. The method of claim 17, wherein the TAN value is calculated using the equation:
$$MOD \text{-} TAN of Sample = \frac{[ \begin{matrix}ml 0.1 Alcoholic KOH * \\ 0.1 N * ( 56100 / 1000 )\end{matrix} ] mg}{weight of sample in grams}$$
